(19) United States
(12) Patent Application Publication
(10) Pub. No.: US 2004/0245671 A1
(43) Pub. Date: Dec. 9, 2004

(54) Apparatus and method for manufacturing a silicone cover for a breast implant

(75) Inventor: Jan Johan Hendrik Smit, Alphen A/D Rijn (NL)

Correspondence Address: PEACOCK MYERS AND ADAMS P C, P O BOX 26927, ALBUQUERQUE, NM, 871256927

(73) Assignee: MENTOR MEDICAL SYSTEMS B.V., Leiden (NL)

(21) Appl. No.: 10/804,738

(22) Filed: Mar. 18, 2004

Related U.S. Application Data
(63) Continuation of application No. PCT/NL02/00611, filed on Sep. 23, 2002.

(30) Foreign Application Priority Data
Sep. 24, 2001 (NL) NL 1019023

(51) Int. Cl. B29C 41/14

(52) U.S. Cl. 264/236; 264/305; 425/270

(57) ABSTRACT

An apparatus for manufacturing a silicone cover for a breast implant, comprising a dipping station for repeatedly immersing at least one mould of said cover in a plastic solution, wherein the mould at its lower side is placed on an adjustable arm such that during operation at least prior to a complete immersion of the mould, an upper end of the mould comes in contact with the plastic solution.

The invention relates to an apparatus and method for manufacturing a silicone cover for a breast implant.

In the prior art such silicone covers are manufactured manually. This is unfavourable with regard to the costs, the possible throughput or production capacity, and the with this production incurred wastage of plastic solution used in the manufacturing method.

It is the object of the invention to improve these aspects.

Silicone covers are produced by dipping the mould that is being used, for example, four times in a silicone solution. The silicone solution used is a methyl solution alternating with a phenyl solution. The purpose of repeated dipping is to provide the silicone cover with the desired thickness.

The phenyl solution is applied as second layer and serves as boundary layer, in order to prevent the so-called “bleeding” or leaking.

Mixing the silicone solution with xylene provides the desired viscosity. When applying four dips, a methyl-phenyl-methyl-methyl layer is obtained.

In accordance with the invention the method for manufacturing a silicone cover for a breast implant is carried out by repeatedly dipping a mould for this cover in a plastic solution, and prior to this is partly immersed in the plastic solution such as to first allow a topside of the mould to come in contact with the solution. After the mould has been repeatedly dipped, at least one curing treatment takes place. Between the dips, there is in general one evaporation phase in which solvent can evaporate. After the last dip this evaporation may preferably take place at elevated temperature.

The invention is also embodied in an apparatus with which this method may be effectively carried out, and which is characterized by at least one dipping station for repeatedly immersing at least one mould of said cover in a plastic solution, wherein the mould at its lower side is placed on an adjustable arm, such that the upper side of the mould stays free of obstructions and that during operation at least prior to a complete immersion of the mould, an upper end of the mould comes in contact with the plastic solution.

Applicants have found that this measure solves a problem that has been impeding a suitable automation of the known method. The simple automation of operations that had previously been carried out manually were shown to lead to the problem that a weak spot is left in the thus manufactured silicone cover caused by the air inclusions in the plastic layer.

With the invention such air inclusions are effectively avoided.

The apparatus is preferably embodied such that the arm can be adjusted in order to position the mould so as to allow the upwardly-oriented end of the mould to be dipped into the plastic solution prior to immersing the entire mould in said solution.

This may be realised simply and economically.

To this end a suitable embodiment of the apparatus is characterized in that the arm has a pivoting point located above the plastic solution, about which pivoting point the arm is adjustable over at least 90°.

In order to provide an effective throughput capacity, the apparatus is further characterized in that, viewed in the direction of processing, the same is provided with an evaporating oven placed after the dipping station, for evaporating an excess of solvent from the plastic solution present on the mould.

It is further useful for a curing oven to be provided succeeding the evaporating oven.

It has further been shown to be desirable for the evaporating oven to be equipped with an inlet and outlet for air, with the inlet in relation to the mould being located in the top of the evaporating oven and the outlet being located at a level with a dipping tank for the mould, provided in the dipping station.

This measure has been shown to be especially important for the effective evaporation of the excess of xylene originating from the plastic solution, without any weak spots being left behind in the final silicone covers manufactured with the apparatus and method in accordance with the invention. This also avoids hazardous fume concentrations in the solvent.

The invention will now be further elucidated with reference to the drawing, which

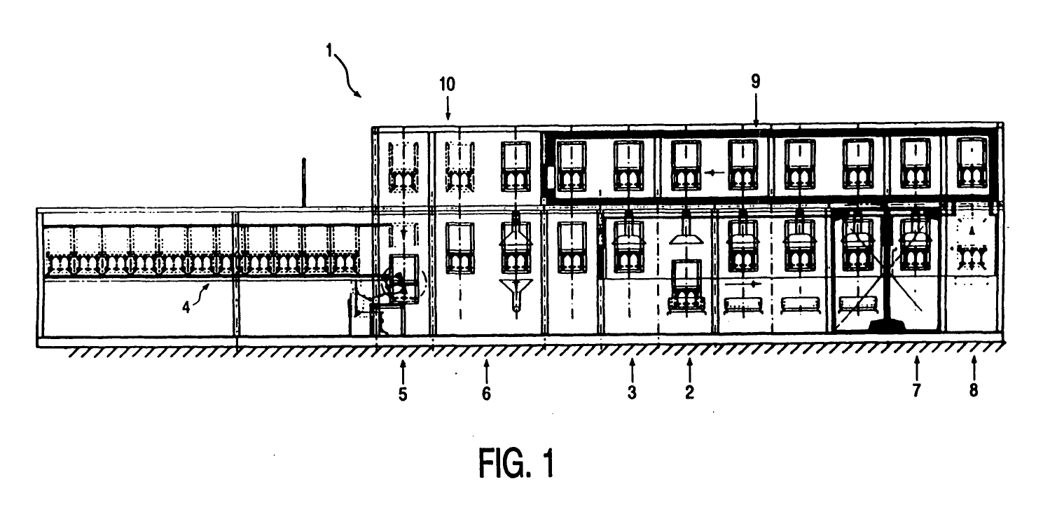

in FIG. 1 shows the apparatus according to the invention in a cross-sectional side view;

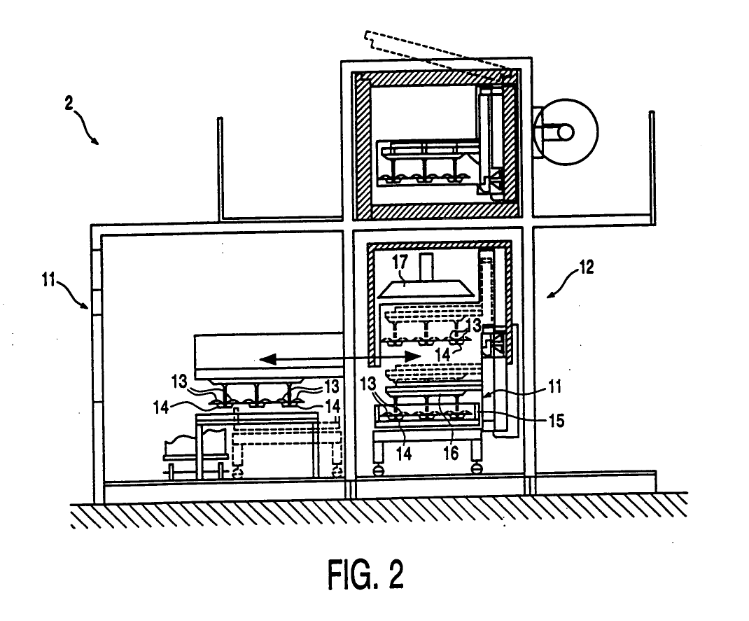

in FIG. 2 shows a cross-section of the apparatus according to the invention at the position of the dipping station.

Identical reference numbers used in the figures refer to similar parts.

FIG. 1 shows the apparatus 1, which serves for the substantially automatic manufacture of a silicone cover for a breast implant. A part of this apparatus 1 is a dipping station 2, wherein a mould is repeatedly dipped into a plastic solution in order to form said cover. It is also possible to provide several, for example, three dipping stations in succession for the repeated dipping of the mould.

Preceding the dipping station (viewed in the installation's direction of operation) there is a preheating oven 3 in which the mould or moulds are preheated. In the case illustrated, the moulds are placed in threefold on a common mandrel that is driven by a conveyer 4. Modifications to this are of course possible.

At the input station 5 the moulds are introduced into the actual apparatus 1 after which the moulds are cleaned in the cleaning station 6. After this cleaning station 6 the moulds are preheated in the preheating oven 3, in the dipping station 2 (or in several dipping stations) the moulds are repeatedly dipped into a plastic solution and the moulds are conveyed further to an evaporating oven 7 for the evaporation of xylene from the plastic solution with which the moulds are coated.

From this evaporating oven 7 the moulds are transported upward by means of a lift 8 to a curing oven 9 where the plastic coatings provided on the moulds are cured. The curing oven 9 is succeeded by a cooling section, and transport to the exhaust area as indicated by reference number 10.

For a further elucidation of the dipping as such, reference is made to FIG. 2.

FIG. 2 shows the dipping station 2 in a cross-sectional view. This dipping station 2 comprises a dipping section 11 and an oven section 12. Both in the dipping section 11 and in the oven section 12, moulds 13 are shown that are placed upside down on an arm 14 allowing vertical transport, in order bring them into a tank 15 filled with a plastic solution, as shown in the dipping section 11. After each such immersion, the moulds 13 are conveyed to an oven section 12 for the exhaustion of xylene that is present in the plastic solution in the mould 15, in order to adjust the desired viscosity.

An essential aspect of the invention is that during the process the arm 14 is operated such that at least prior to the moulds 13 being totally immersed in the bath of plastic in the tank 15, an upper end of the mould 13 is contacted with this plastic solution by adjusting the arm 14 such that it forms an angle with the vertical in a manner that allows the upper end of the mould 13 to be dipped into the plastic solution before the entire mould 13 disappears in this solution. To this end the arm 14 is provided with a pivoting point located above the plastic solution at the height of a connecting shaft 16, to which in the case illustrated further arms 14 with moulds 13 are coupled, and at which pivoting point the arms 14 can be adjusted over at least 90°.

The evaporating oven 7 has an inlet 17 and an outlet 18 for air wherein, with respect to the mould 13, the inlet 17 is located in the top of the evaporating oven 7, and wherein the outlet 18 is located at the height of a dipping tank for the mould that is provided in the dipping station 2. This is completely obvious to the person skilled in the art and is therefore not shown in the figure.

The above specification must be understood to be a non-limiting exemplary embodiment of the apparatus and method according to the invention. Numerous variations and modifications may be applied to this apparatus and method, all falling within the scope of the invention. The protection to be conferred on the invention is therefore determined by the appended claims only.

What is claimed is:

1. An apparatus for manufacturing a silicone cover for a breast implant, having a dipping station for repeatedly immersing at least one mould of said cover in a plastic solution, wherein the mould at its lower side is placed on an adjustable arm, such that an upper side of the mould stays free of obstructions, wherein during operation the arm can be adjusted in order to position the mould so as to allow an upwardly-oriented end of the mould to be dipped into the plastic solution prior to immersing the entire mould in said solution.

2. An apparatus according to claim 1, wherein the arm has a pivoting point located above the plastic solution, about which pivoting point the arm is adjustable over at least 90°.

3. An apparatus according to claim 1, wherein viewed in the direction of processing, the same is provided with an evaporating oven placed after the dipping station, for evaporating an excess of solvent from the plastic solution present on the mould.

4. An apparatus according to claim 3, wherein a curing oven is provided succeeding the evaporating oven.

5. An apparatus according to claim 3, wherein the evaporating oven is equipped with an inlet and outlet for air, with the inlet in relation to the mould being located in a top of the evaporating oven and the outlet being located at a height of a dipping tank for the mould provided in the dipping station.

6. A method for manufacturing a silicone cover for a breast implant, wherein a mould for this cover is repeatedly dipped in a plastic solution, and after repeated dipping of the mould, at least one curing treatment takes place wherein prior to said repeated dipping the mould is partly immersed in the plastic solution such as to first allow a topside of the mould to come in contact with the solution.

7. A method according to claim 6, wherein after the last dipping operation, solvent is evaporated at an elevated temperature.
